(19) United States
(12) Patent Application Publication
(10) Pub. No.: US 2002/0128976 A1
(43) Pub. Date: Sep. 12, 2002

(54) Method and system for tracking software licenses and usage

(75) Inventors: Kevin O'Connor, Marblehead, MA (US); Alex Kotopoulis, San Jose, CA (US); Wolfgang Karas, Horn (AT)

Correspondence Address: DARBY & DARBY P.C., 805 Third Avenue, New York, NY, 10022, US

(73) Assignee: Segue Software, Inc.

(21) Appl. No.: 09/969,386

(22) Filed: Oct. 1, 2001

Related U.S. Application Data
(60) Provisional application No. 60/261,983, filed on Jan. 11, 2001.

(51) Int. Cl. G06F 17/60

(52) U.S. Cl. 705/59; 705/65

(57) ABSTRACT

Method and system for discrete soft handoff of a mobile terminal in a wireless CDMA network. A plurality of mobile terminal-base station channels used for soft handoff are reserved to perform soft handoff of a mobile terminal. Soft handoff of the mobile terminal is then performed in a discrete fashion by first predicting which of the reserved channels will be “strong” and “weak” channels for transmission of the next CDMA data frame. At least one of the strong channels is included in the active set of handoff legs used to transmit the next CDMA data frame. The next data frame is then transmitted via only those channels within the active set. This process repeats, wherein the strong and weak channels are predicted prior to the transmission of each CDMA data frame, at least one strong channel is included in the active set for each CDMA data frame, and each CDMA data frame is transmitted via those channels in the active set. Soft handoff occurs because those channels used to communicate each CDMA data frame will change based on the predicted channel strength for each reserved handoff leg. Because weak channels are not used for soft handoff, additional processing complexity, power consumption, and network architecture difficulties associated with prior art soft handoff methods are avoided. Yet there is no substantial loss in performance, because those CDMA data frames that would have been communicated over weak channels are insignificant when a best CDMA data frame is obtained by either CDMA frame aggregation or selection techniques. Thus, the present invention reduces processing requirements, power consumption, and architectural difficulties associated with soft handoff at substantially no performance loss.

This application claims priority pursuant to 35 U.S.C. §119 from Provisional Patent Application Serial No. 60/261,983 filed Jan. 11, 2001, the entire disclosure of which is hereby incorporated by reference.

### FIELD OF THE INVENTION

The invention relates to computer systems and more specifically to licensing and tracking the use of software operating on computer systems.

### BACKGROUND

Software products are typically licensed in perpetuity, which is similar to purchasing a book. Some software products are licensed on a renewable or per-use basis, which is similar to renting a movie. Commercial software products are often licensed for use by certain named users or a stipulated maximum number of concurrent users.

Some licensing arrangements depend on automated computer identification to prevent unauthorized use of the licensed software. However, this limits the authorized user to use of the software exclusively on a particular computer.

What is needed is a more flexible licensing arrangement that is enforceable by a supervisory software application. The present invention addresses this and other needs.

### SUMMARY OF THE INVENTION

The present invention is a method and system for automated licensing and monitoring of usage of software applications operating on a computer system. The present invention is especially suitable for use with licensing arrangements wherein a software product is licensed based on usage of the software. The method involves monitoring the use of the software on any computer, whether stand-alone or in a network. The monitoring system helps prevent use of the software when the use would be inconsistent with the terms of the applicable license.

In the present invention, the terms of the license are converted to a consumption rule or set of rules. Setting up the rules in accordance with a license is conceptually independent of the software product subject to the license, the licensee/users, or any computer. The license, as manifested in the rules, is portable without compromising the safeguard against tampering with the license or other means of unauthorized use of the software. Portability means that the license may be applied to use of the software product on one computer and then transported to another computer where the same license is now applied to use of the software product on the second computer. There is no inherent limit on the number of times a license may be relocated, also referred to as rehosted.

Tokens are employed to track the uses of the licensed software product. A license arrangement specifies the number of tokens that maybe consumed. As the software operates, tokens are consumed according to the consumption rules. For example, one token is consumed for each launch of the software covered by the license. When all the tokens are consumed the license expires.

The consumption of tokens is controlled by a query system wherein the software product queries the monitoring system requesting permission to proceed with operation of the software. The monitoring system grants or denies permission based on the remaining available tokens and the consumption rules. The query process is also referred to as the license retrieval. When permission is granted, tokens are consumed which may also be referred to as allocating licenses. The monitoring system is encoded and/or designed to provide security by for example, verifying the software product and preventing use of unauthorized copies of the product. The monitoring process may log the software operations according to user, computer, time, type of operation, or some other objective criteria.

### BRIEF DESCRIPTION OF THE DRAWINGS

The foregoing and other features of the present invention will be more readily apparent from the following detailed description and drawings of illustrative embodiments of the invention in which:

FIG. 1 is a block diagram of the components of the preferred embodiment of the present invention;

FIG. 2 is a flow diagram illustrating an overview of the preferred embodiment of the present invention;

FIG. 3 is a chart of an exemplary flow of license assignment and consumption in accordance with the preferred embodiment;

FIG. 4 is a chart of an exemplary progression of consumption in accordance with the preferred embodiment; and

FIG. 5 is a graphical illustration of an exemplary report in accordance with the preferred embodiment.

### DETAILED DESCRIPTION OF THE PREFERRED EMBODIMENT

In the preferred embodiment, the automated licensing and monitoring is applied to software licenses that are based on particular usage metrics, as appropriate for the individual software product. Two items are determined from the terms of the license: (a) one or more consumption rules and (b) what a token represents. For example, if the license is based on the number of users that use the software product, the token may represent a user using the product. One consumption rule may be defined as one token being consumed for each new user, regardless of the number of times the software product is used by the user. Alternatively, one consumption rule may be defined as one token is consumed for each use of the software for each user. Another consumption rule may be a factor of time, i.e., the consumption rule may be defined as one token is consumed for each user per day, such that if the same user uses the software twice in the same day, only one token is consumed, but one use on each of two consecutive days consumes two tokens. Finally, a particularly useful consumption rule is based on the number of users that concurrently use the software product within a predefined time period, e.g., 24 hours. Over the course of the time period, tokens are consumed only when there is an increase over the highest number of concurrent users. Whatever the usage metric, consumption rule(s) are defined according to the terms of the license and the balance of available tokens is set according to the amount determined by the licensee, i.e., the licensee agrees to certain licensing terms and then specifies the number of tokens desired and presumably purchased. The licensee is provide with flexibility in the amount of expenditure by having the option of purchasing a varying number of tokens at any given time. For example, the licensee may want to start with a small number of tokens and increase the size of the license and number of tokens as the need arises. Similarly, the licensing arrangement allows the licensor to closely monitor and enforce the use of the licenses granted.

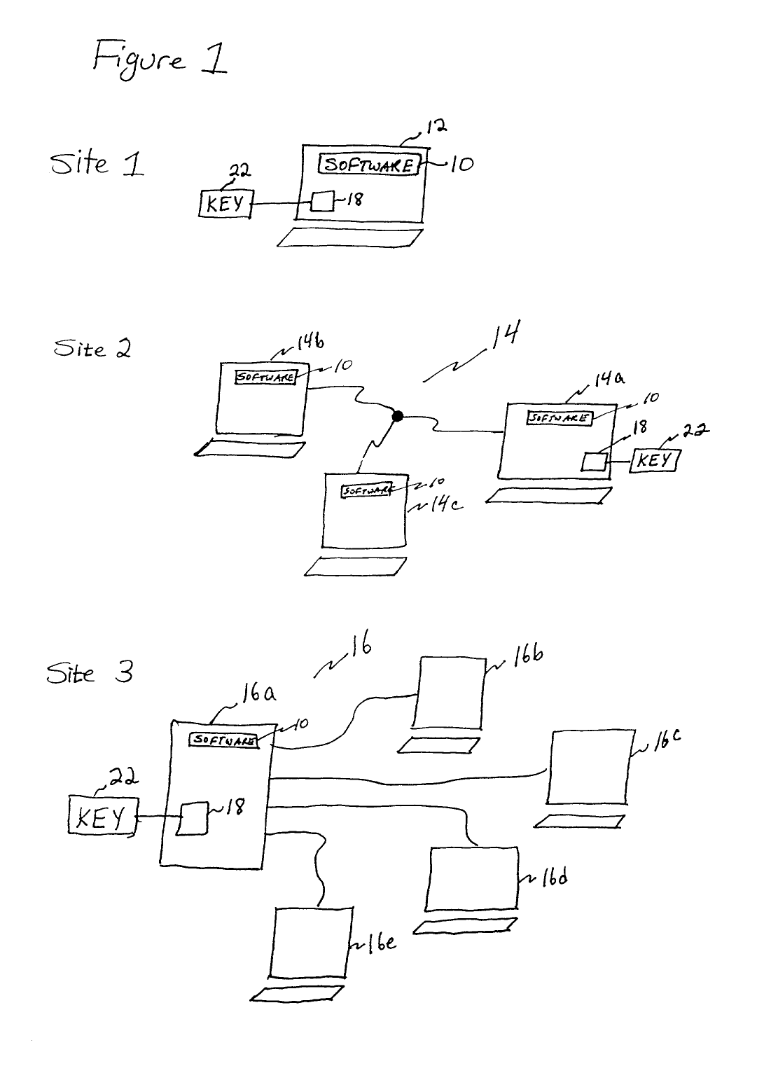

Referring to FIG. 1, in the preferred embodiment of the present invention, the licensed software product 10 may reside on a plurality of computers at various locations, for example Site 1 having a stand alone personal computer 12, Site 2 having a group of computers forming a LAN 14, and Site 3 having a server computer 16 alone or connected to one or more computers in a LAN, WAN, or distributed network.

For each license established or purchased, a key 22 is generated to provide a secure mechanism for associating authorized use of the software product with the appropriate license. The key may be a hardware device, known in the industry as a dongle, that attaches to the computer where the licensed software is to be executed. A dongle is a copy protection device and operates in conjunction with software, as is required for most hardware. In the preferred embodiment, this software is referred to as license server software 18. The license server software is installed on the computer to which the dongle is attached.

The key maintains the balance of tokens available for consumption as well as other information particular to the license and associated consumption rules. The key is controlled by the license server software and together process the tokens in accordance with the consumption rules, thus enforcing the license. The key is resistant to tampering by the user or any unauthorized entity. Neither the software product nor the user may write to or change the contents of the key. Only the license server software may update information in the key. The security provided by the key prevents fraudulent overriding of licensing maintenance data to which other licensing schemes are susceptible. The security is not dependent on the computer or identification thereof. The key communicates only with the license server. It does not communicate directly with the software product. The key is defined only by the license and is therefore independent of the computer or software product. The key maybe pre-loaded with the appropriate information according to the terms of the license.

The portability of the key is what allows the license to be portable without compromising the integrity of the licensing terms. The key may be attached to the personal computer 12 at Site 1 for a period of time. Subsequently the key may be detached (uninstalled), relocated to Site 2, and attached to another computer 14a. Use of the software at site 2 consumes tokens under the same license applied at Site 1 because the license travels with the key. Multiple users concurrently using the software on three computers 14a, 14b, 14c, all consume tokens associated with the one key attached to the LAN. Subsequently, the key may be relocated to a hardware server 16a at Site 3.

To enable the automated licensing arrangement, the software product is adapted to interface with the license server software 18. The adaption is achieved using an application program interface (“API”) designed to interface with the license server 18. Using the API in the software product facilitates communication between the product and the license server. As the software operates, the API automatically initiates communication with the license server at the appropriate times to enforce the licensing terms and track the consumption of tokens. Aside from the interface, the software product 10 is not aware of the licensing process carried on by the license server software 18 and the key 22.

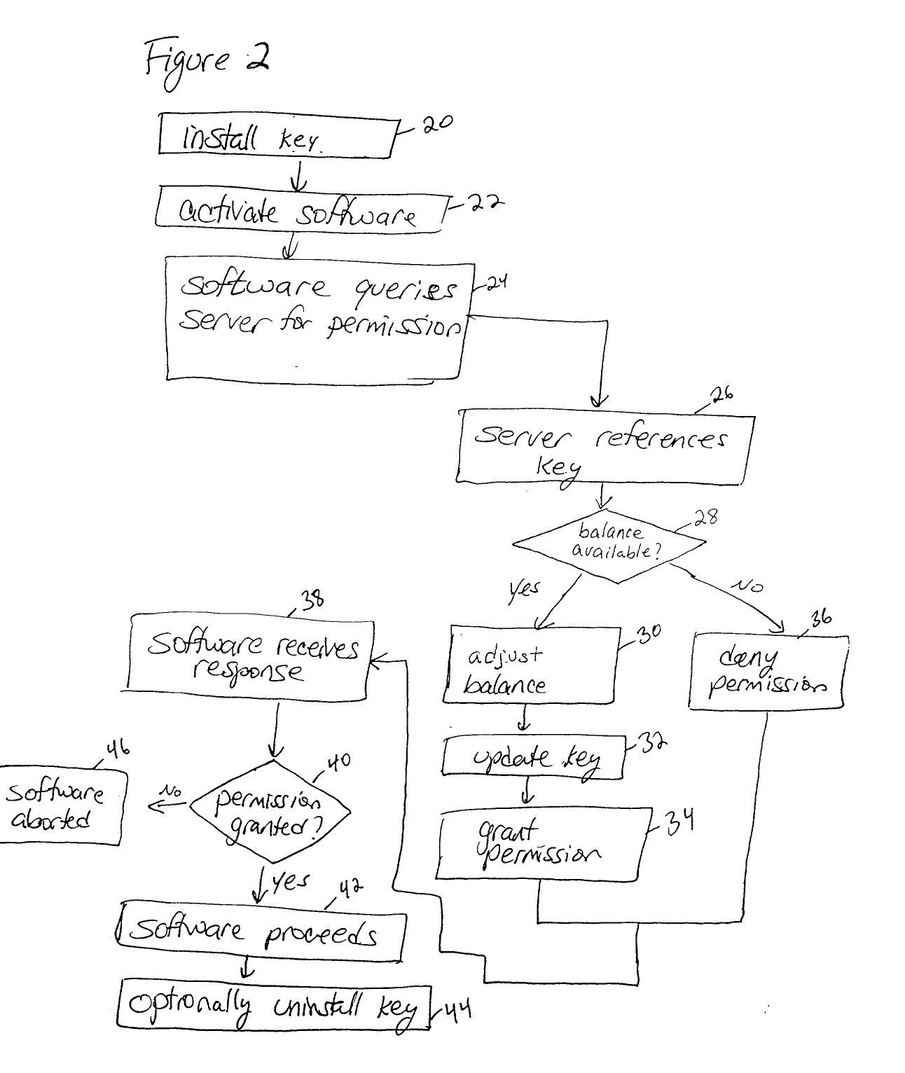

Referring to FIG. 2, monitoring and enforcing the license is carried out by the cooperation of the software product, the license server, and the key. At step 20, the key is installed on a computer having access to the licensed software product. When the software is activated, at step 22, the software queries the license server for permission to be used, at step 24. This is performed automatically in the background due to the API. At step 26, the license server references the key to determine the current balance of tokens. At step 28, the license server determines the number of tokens needed to allow the use of the software, which is typically one token per use. The license server then determines whether there is sufficient balance to cover the tokens needed. If there is sufficient balance of tokens, at step 30 the balance is reduced by the number of tokens consumed, at step 32 the key is updated, and at step 34 permission is granted. Alternatively, if at step 28 it is determined that there are insufficient tokens, at step 36 permission is denied. At step 38, the software receives the license server's response regarding permission. At step 40 the software product determines whether permission was granted. If permission is granted, then at step 42 the software product proceeds. Optionally at some point the key may be uninstalled and relocated. Where permission is denied, the process proceeds instead to step 46 and the software product is aborted. Appropriate error messages may be produced to inform the user of the status of the license.

It should be readily apparent that the tracking of the consumed tokens may be maintained by a balance of the tokens consumed instead of a balance of the available tokens without any deviation from the present invention. The key maintains the tally of consumed tokens along with an indication of the budget of tokens, i.e., typically the number of tokens purchased. The tally or balance of consumed tokens is then compared to the budget to determine whether the maximum usage has been reached.

Steps 28 and 30 effectively implement a particular consumption rule, i.e., one token consumed per use of the software product. Where other consumption rules apply, the appropriate calculations are made to determine whether permission is granted and the key is updated accordingly. Also, the license server may maintain a policy for each different licensed software product. Before step 28, the license server may reference the appropriate policy in determining whether permission is granted. The key provides identification of the software product along with the token information.

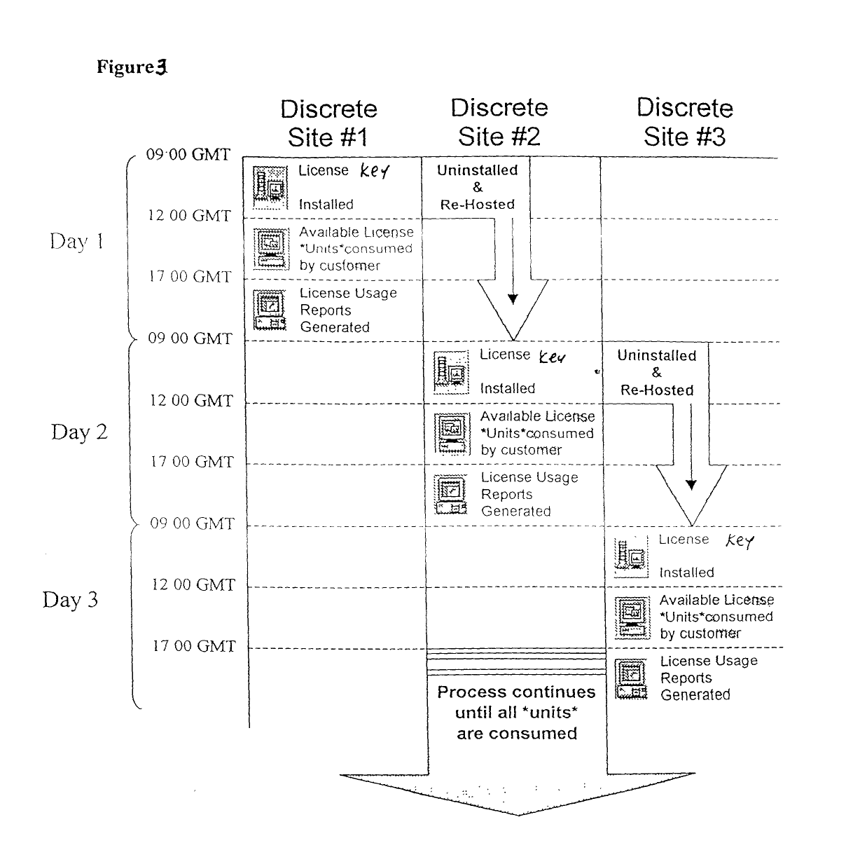

Referring to FIG. 3, therein is shown an example of a consulting company having three clients at sites 1, 2, and 3. On Day 1, a consultant first visits Site 1 and needs to use the licensed software. The consultant installs the key on a computer at Site 1. The consultant proceeds to use the licensed software and in the background the license server is contacted, the key is referenced, and permission for use is granted. The appropriate number of tokens are consumed according to the exact use and the consumption rules associated with the license terms. At the end of the day the consultant completes their use of the software and generates a report of the uses at Site 1. The next day the consultant visits another client at a different location namely Site 2. The key having been uninstalled from Site 1, is now installed at Site 2. Once again uses are only permitted provided there are sufficient available tokens and the consumed tokens are deducted from the balance. If the consultant gave a demonstration for a group of 50 users each operating the licensed software, and the consumption rule requires one token for each user, 50 tokens would be consumed. At the end of the day, the consultant may generate a report and uninstall the key before leaving Site 2. This process may continue until all the tokens are consumed. The reports may be used by the consulting company as a record of their use with respect to the license agreement. The report is also useful for billing the consultant's clients in a manner proportionate with the use of the software.

The automated licensing use arrangement is particularly suited for monitoring the use of software designed to test other software applications. The “software-testing” products are applications that run a subject application under simulated conditions. For example, an application that provides searching capabilities for the public library is designed to handle many user requests simultaneously. The software testing product is designed to run the library query program simulating the multitude of users. These are virtual users. The licensing terms provide that tokens are consumed based on the number of virtual users rather than the single real user (operator) operating the software testing product. Other than this conceptual difference, the licensing arrangement operates the same for real users or virtual users.

Typically, the operator tests the underlying application for a predetermined load of virtual users. For example, the operator tests the application with a load of 500 virtual users. In the method described above at step 24 the testing software product has to query the license server for permission 500 times. Alternatively, the software may request in a single query to the license server permission for 500 users. Then at step 28 the license server determines whether there is a sufficient balance and proceeds accordingly.

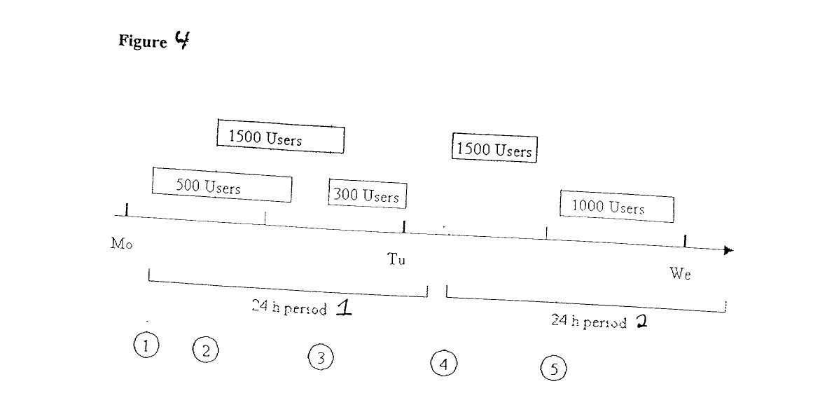

Referring to FIG. 4, therein is illustrated an example of usage on a time line by groups of users. In this example, the license provides for 10,000 tokens and the consumption rule is that for each time period, the highest number of concurrent users during that period dictates the number of tokens consumed. A variable “high” parameter keeps track of the highest number of concurrent users per period and is reset at the end of each period. In this example there are two real consumers, bsmith and cjones, each using the licensed software on several occasions, sharing the same key. At action point 1, cjones executes the software for 500 virtual users. The total concurrent users is 500 and the current high is 500. The number of tokens consumed for this period as of action point 1 is 500 and the balance is 9500. At action point 2, bsmith starts another instance of the software using the same key and operating 1500 virtual users. This brings the number of concurrent users up to 2000 and the current high to 2000. An additional 1500 tokens are consumed during this period. Some time before action point 3, cjones concludes the session with 500 users, bringing the total concurrent users down to 1500 in bsmith's session. At action point 3, cjones initiates another session with 300 virtual users. Now the total concurrent users rises to 1800 which is less than the previous high of 2000 concurrent users. Therefore, the high is unchanged and no additional tokens are consumed during this period. At action point 4, period Monday ends and period Tuesday begins which resets the high to zero for this period. The balance of tokens remains and is not reset during the life of the license. At action point 4 bsmith starts a new session with 1500 virtual users. The number of concurrent users and high are 1500. 1500 tokens are consumed for this period and deducted from the balance. At point 5, bsmith's session has ended and cjones later starts a session with 1000 virtual users. This is less than the previous high of 1500 concurrent users, and therefore, the high is unchanged and no additional tokens are consumed. The usage of FIG. 4 is summarized in the following table:

| | | | | Highest | |
|---|---|---|---|---|---|
| | | | | number | |
| | | | Concurrent | of con- | |
| | | Action: | users at | current | |
| | Action | Number | action | users per | Balance |
| Period | point | of users | point | period | tokens |
| 1 | | 0 | 0 | 0 | 10,000 |
| | 1 | 500 | 500 | 500 | 9,500 |
| | 2 | 1,500 | 2,000 | 2,000 | 8,000 |
| | 3 | 300 | 1,800 | 2,000 | 8,000 |
| 2 | | 0 | 0 | 0 | 8,000 |
| | 4 | 1,500 | 1,500 | 1,500 | 6,500 |
| | 5 | 1,000 | 1,500 | 1,500 | 6,500 |

As with the example shown in FIG. 3, this process may continue until all the tokens are consumed. Once the tokens are depleted, no further uses of the software product are permitted unless the license is renewed or a new license is obtained, resetting the balance of tokens.

Alternatively, if the consumption rule provides that for each use a token is consumed, then at action point 3 an additional 300 tokens would be consumed and the balance reduced to 7,700 and again at action point 5 an additional 1000 tokens would be consumed reducing the balance to 5,200.

Other usage metrics may be based on any quantifiable software operation, including queries and measurement of processed data. For example, a sorting product may be licensed based on how many sort operations the licensee executes, the amount of data or number of records sorted, or some combination of factors. The token is defined to reflect the type of licensing metric employed. The licensing terms may determine the maximum number of tokens available. The number of tokens represent the maximum number of operations that may be performed by the software under the license. The license may cover all operations or a selection or subset of software operations. Before an operation is performed, the appropriate number of tokens are assigned to the operation. Upon completion of the operation, the appropriate number of units are deemed consumed Alternatively, where the usage metric is based on the operations or transaction level, multiple licenses may be employed. Each license is associated with one type of operation or transaction and each time the operation or transaction is performed, a token is consumed. When managing the tokens consumed on a transaction basis, single or multiple balances may be used. A single balance indicates that tokens consumed for any transaction are deducted from a single balance. Alternatively, where multiple balances are employed, the consumed token is deducted only from the balance associated with the operation or transaction that resulted in consumption. For example, generating a script and running a script are two operations and each may result in consumption of tokens from joint or separate tallies.

Each time the software prepares to execute any of the operations covered by the license, the monitoring process determines whether there are sufficient tokens available for the operation. If there are available tokens, they are assigned to the instance of operation and the software proceeds with the operation. The assigned token may monitor the software usage during the operation. When the operation is complete, the unit is deemed consumed. The usage information accumulated by the token regarding the last operation may be stored at a central location.

Various mechanisms may be used to provide additional tokens to a licensee after all the allotted tokens are consumed. One mechanism is that the key is replaced with another key having been preset with available tokens. Alternatively, the key may be sent to the licensor for processing in which the licensor is authorized to reset or refill the designation of available tokens. Another alternative is to remotely add or reset the available tokens indicated in the key. Where remote access is used to update or change the information in the key, additional measures of security are employed to avoid fraud, such as tampering with the license or using the license with unauthorized copies of the software product.

The license server software has a monitoring process and reporting process. The monitoring process monitors the usage of the software products as described above. The reporting process generates usage reports of the software product. The report consists of information about the consumption of the license (tokens) quantifying the usage of the software at a location. The format of the report may vary in format depending on the consumption rules. The reports are generated on demand by the user. Optionally the reports may also be generated automatically each time the key is uninstalled. The consumption information collected locally may also be transmitted to a central location for further processing.

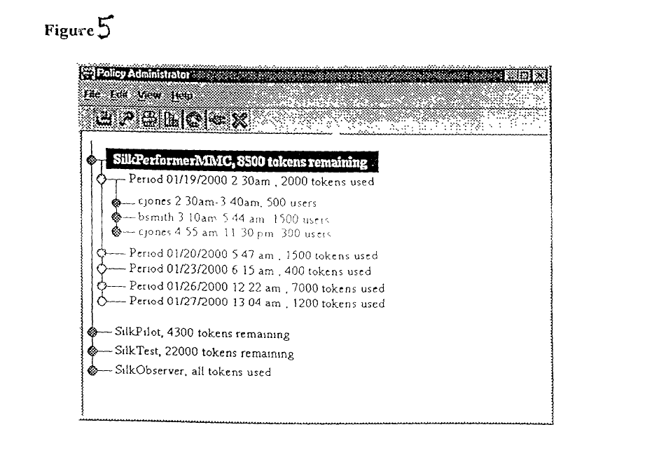

FIG. 5 illustrates a report generated for the example set forth in reference to FIG. 4. For each software product, the report indicates the number of available tokens. The report provides a break down of the number of tokens used for the preceding period of monitoring. The report also indicates the real users (cjones, bsmith) related to the time period and number of virtual users. For example, referring to FIG. 5, the report covers four licensed software products: Silk Performer MMC, Silk Pilot, Silk Test, and Silk Observer. For each of the four products, the report indicates the number of remaining available tokens, i.e. 8500, 4300, 22000, and 0 respectively. Further details may be viewed for each product, for example, the details for Silk Performer is illustrated. The details include the Period identified by the start date and time (periods are 24-hours) and the number of tokens used during that period. For example, five periods are illustrated: Jan. 19, 20, 23, 26, and 27, along with the number of tokens used in each period, i.e., 2000, 1500, 400, 7000, and 1200 tokens respectively. For a given period, further details may be viewed, for example, the real users. For the Period of Jan. 1, 2000, there were two users cjones and bsmith. Cjones used the Silk Performer twice during this period. The start and end time of the use is indicated as well as number of tokens consumed or the number of virtual users. At this level of detail, the report indicates that on Jan. 1, 2000, cjones started at 2:30 am with a load of 500 virtual users and ended at 3:40 am; bsmith started at 3:10 am with a load of 1500 users and ended at 5:44 am; and cjones started again at 4:55 am with a load of 300 virtual users and ended at 11:30 pm.

While the invention has been particularly shown and described with reference to preferred embodiments thereof, it will be understood by those skilled in the art that various changes in form and details may be made therein without departing from the spirit and scope of the invention.

We claim:

1. A method for tracking usage of a software product, the method comprising the steps of:
(a) receiving a request for permission to use the software product;
(b) referencing a portable security device to determine a current balance of usage tokens, the portable security device being moveable between a plurality of locations and allowing monitored usage of the software product at any of the locations where the portable security device is located;
(c) determining a number of usage tokens corresponding to the requested use in accordance with one or more usage rules;
(d) determining whether the current balance is at least equal to the number of usage tokens corresponding to the requested use and if so then:
(1) decrementing the current balance of usage tokens by the number of usage tokens corresponding to the requested use; and
(2) authorizing the request for permission to use the software product;
else, (e) denying the request for permission to use the software product.

2. The method of claim 1, wherein steps (b) through (e) are repeated in the case of continued use of the software product.

3. The method of claim 1, wherein the request for permission to use the software product comprises a request to use the software product for a plurality of virtual users.

4. The method of claim 1, wherein the step of determining a number of usage tokens comprises the step of generating one or more consumption rules for the usage tokens.

5. The method of claim 1, further comprising the step of using a predefined application program interface to facilitate communication between the software product and the portable security device.

6. The method of claim 1, further comprising the steps of:
maintaining, in the portable security device, a plurality of current balances of tokens wherein each balance is associated with a type of transaction that may be performed by the software product; and
referencing the appropriate current balance contained in the portable security device depending on the type of transaction involved in the request for use of the software product.

7. The method of claim 1, further comprising the step of generating a usage report indicating at least the number of usage tokens corresponding to the requested use and the current balance.

8. The method of claim 1, wherein said one or more usage rules include a rule which allocates one token for each user operating the software product.

9. The method of claim 1, wherein said one or more usage rules include a rule which allocates one token for each virtual user operating the software product.

10. The method of claim 1, wherein said one or more usage rules include a rule which allocates one token for each transaction performed by the software product.

11. The method of claim 1, wherein said one or more usage rules include a rule which allocates one token for each use of the software product.

12. The method of claim 1, further comprising the step of determining a number of concurrent users and wherein said one or more usage rules include a rule which allocates the number of tokens corresponding to the number of concurrent users.

13. The method of claim 1, wherein said one or more usage rules include a rule which allocates one token for each user for each period of time.

14. The method of claim 1, wherein said one or more usage rules include a rule which allocates one token for each virtual user for each period of time.

15. The method of claim 1, wherein said one or more usage rules include a rule which allocates one token for each use for each period of time.

16. The method of claim 1, further comprising the steps of:
setting a current maximum to zero at the beginning of a period of time;
tracking a number of previous concurrent user within the period of time;
determining a number of additional users corresponding to the requested use;
determining a number of concurrent users as the sum of the number of previous concurrent and the number of additional users;
determining an excess of users as an amount of which the number of concurrent users exceeds the current maximum;
determining a number of consumed tokens as a function of the excess of users;
decrementing the current balance of usage tokens by the number of consumed tokens; and
incrementing the current maximum by the number of excess of users.

17. A method for tracking usage of a software product, the method comprising the steps of:
(a) receiving a request for permission to use the software product;
(b) referencing a portable security device to determine a current balance of usage tokens and a number of allocated tokens, the portable security device being moveable between a plurality of locations and allowing monitored usage of the software product at any of the locations where the portable security device is located;
(c) determining a number of usage tokens corresponding to the requested use in accordance with one or more usage rules;
(d) determining whether the number of allocated tokens is at least equal to the sum of the current balance and the number of usage tokens corresponding to the requested use and if so then:
(1) incrementing the current balance of usage tokens by the number of usage tokens corresponding to the requested use; and
(2) authorizing the request for permission to use the software product;
else, (e) denying the request for permission to use the software product.

18. A system for automated licensing of a software product subject to a license agreement, the system comprising:
a portable security device containing a balance of tokens and information including one or more license terms based on the license agreement; and
a server module for interfacing between the portable security device and the software product, wherein the server module operates to determine whether operation of the software product is permitted in accordance with the balance of tokens and the information in the portable security device and update the balance of tokens in the portable security device when the software product is operated.

19. A system for tracking usage of a software product operable on a plurality of user computers, the system comprising:
a portable security device moveable between said plurality of user computers, said device containing at least a balance of tokens;
a server module for interfacing between the portable security device and the software product, wherein the server module operates to detect a request for operation of the software product, determine a number of tokens corresponding to the request, determine whether such operation of the software product is permitted in accordance with the balance of tokens in the portable security device, and adjust the balance of tokens in the portable security device by the number of tokens corresponding to the request when the software product is operated.

20. A system for tracking usage of a software product, comprising a processor, and a memory storing processing instructions for controlling the processor, the processor operative with the processing instructions for:
(a) receiving a request for permission to use the software product;
(b) referencing a portable security device to determine a current balance of usage tokens, the portable security device being moveable between a plurality of locations and allowing monitored usage of the software product at any of the locations where the portable security device is located;
(c) determining a number of usage tokens corresponding to the requested use in accordance with one or more usage rules;
(d) determining whether the current balance is at least equal to the number of usage tokens corresponding to the requested use and if so then:
(1) decrementing the current balance of usage tokens by the number of usage tokens corresponding to the requested use; and
(2) authorizing the request for permission to use the software product;
else, (e) denying the request for permission to use the software product.

21. A system for tracking usage of a software product, comprising a processor, and a memory storing processing instructions for controlling the processor, the processor operative with the processing instructions for:
(a) receiving a request for permission to use the software product;
(b) referencing a portable security device to determine a current balance of usage tokens and a number of allocated tokens, the portable security device being moveable between a plurality of locations and allowing monitored usage of the software product at any of the locations where the portable security device is located;
(c) determining a number of usage tokens corresponding to the requested use in accordance with one or more usage rules;
(d) determining whether the number of allocated tokens is at least equal to the sum of the current balance and the number of usage tokens corresponding to the requested use and if so then:
(1) incrementing the current balance of usage tokens by the number of usage tokens corresponding to the requested use; and
(2) authorizing the request for permission to use the software product;
else, (e) denying the request for permission to use the software product.

22. A computer readable medium encoded with processing instructions for implementing a method for tracking usage of a software product, the method comprising:
maintaining balance of tokens stored on a portable security device;
detecting a request for operation of the software product;
determining a number of tokens corresponding to the request;
determining whether such operation of the software product is permitted in accordance with the balance of tokens in the portable security device; and
adjusting the balance of tokens in the portable security device by the number of tokens corresponding to the request when the software product is operated.

23. A computer readable medium encoded with processing instructions for implementing a method for tracking usage of a software product, the method comprising:
(a) receiving a request for permission to use the software product;
(b) referencing a portable security device to determine a current balance of usage tokens, the portable security device being moveable between a plurality of locations and allowing monitored usage of the software product at any of the locations where the portable security device is located;
(c) determining a number of usage tokens corresponding to the requested use in accordance with one or more usage rules;
(d) determining whether the current balance is at least equal to the number of usage tokens corresponding to the requested use and if so then:
(1) decrementing the current balance of usage tokens by the number of usage tokens corresponding to the requested use; and
(2) authorizing the request for permission to use the software product;
else, (e) denying the request for permission to use the software product.

24. A computer readable medium encoded with processing instructions for implementing a method for tracking usage of a software product, the method comprising:
(a) receiving a request for permission to use the software product;
(b) referencing a portable security device to determine a current balance of usage tokens and a number of allocated tokens, the portable security device being moveable between a plurality of locations and allowing monitored usage of the software product at any of the locations where the portable security device is located;
(c) determining a number of usage tokens corresponding to the requested use in accordance with one or more usage rules;
(d) determining whether the number of allocated tokens is at least equal to the sum of the current balance and the number of usage tokens corresponding to the requested use and if so then:
(1) incrementing the current balance of usage tokens by the number of usage tokens corresponding to the requested use; and
(2) authorizing the request for permission to use the software product;
else, (e) denying the request for permission to use the software product.
